(19) United States
(12) Patent Application Publication
(10) Pub. No.: US 2005/0183993 A1
(43) Pub. Date: Aug. 25, 2005

(54) Screen

(76) Inventor: Helmuth Gabl, Graz (AT)

Correspondence Address: ALIX YALE & RISTAS LLP, 750 MAIN STREET, SUITE 1400, HARTFORD, CT, 06103, US

(21) Appl. No.: 10/966,579

(22) Filed: Oct. 15, 2004

(30) Foreign Application Priority Data
Oct. 15, 2003 (AT) A 1623/2003

(51) Int. Cl. B03B 7/00

(52) U.S. Cl. 209/44

(57) ABSTRACT

A screen for cleaning a pulp suspension includes a housing forming a separation chamber. The housing includes a pulp suspension feed, a reject outlet and an accept outlet. A dividing wall disposed within the housing divides the separation chamber into a suspension chamber and an accept chamber, with the pulp suspension feed and the reject outlet being in fluid communication with the suspension chamber and the accept outlet being in fluid communication with the accept chamber. The dividing wall includes a screen structure having a suspension side adjacent the suspension chamber and an oppositely disposed accept side adjacent the accept chamber. At least the suspension side of the screen structure has profiling for generating turbulence in the pulp suspension flowing against the screen structure to create a self-cleaning effect in the screen structure.

### BACKGROUND OF THE INVENTION

This invention relates generally to screens. More particularly, the present invention relates to screens for cleaning a pulp suspension.

Screens are machines that are used in the paper industry to clean a pulp suspension consisting of water, fibers, and dirt particles. Here, a pulp flow is fed through a screening device, where the accept flow, comprising water and fibers, flows through the screen. A partial flow, known as the reject flow and consisting of water, fibers, and dirt particles, is generally removed at the end opposite the feed flow. Thus, the screens fractionate solids particles suspended in water. By contrast, filtration processes separate the liquid from the solids.

In general, a screen of this type has an axially symmetrical design and comprises a housing with a pulp feed, a cylindrical screen basket, usually with perforations or vertical slots, and a rotating rotor. The rotor is responsible for keeping the screen slots clear, which is achieved by vanes rotating just over the surface of the screen. The accept flow is collected in a so-called accept chamber and removed in radial direction. The reject flow is generally brought to a reject chamber, which is usually annular, at a point of the screen basket opposite the feed and removed from here at a tangent. A screen of this type is known from EP 1 122 358 A2, for example.

The disadvantage of these known screens is that rotors are essential as a cleaning device to keep the screen slots clear, and these moving parts are susceptible to faults, consume substantial amounts of driving energy, and also frequently lead to problems with leaks at the screen. Furthermore, these screens require a relatively high level of maintenance and are thus expensive to run.

Pressurized flat screens are also known, where the screen is likewise kept clear of clogging by means of moving cleaning devices (rotors). This type of screen largely operates in a feed flow consistency range of 2.5% and more. The screen surfaces are small, thus the obtainable throughput is low.

In order to alleviate the problems caused by screens with a rotating screen clearing device, screen devices have been suggested where pulsating pressures in the suspension flow fed to the screen are used instead of a moving clearing device to keep the screen free of clogging. The disadvantages of this kind of screen lie in the high energy consumption required to generate the pressure impulses, substantial demands on the suspension pump, and undesirable transmission of the pressure impulses beyond the screen and into other plant components.

In addition, vibration screens designed as flat screens are known, however they are not pressurized. Their screening efficiency and their throughput are very low, which is why this type of vibration screen is rarely still in use except as a so-called final stage screen.

### SUMMARY OF THE INVENTION

The present invention provides a solution to the problems inherent to state-of-the-art screens. In particular, the present invention offers a solution to the problem of keeping the screen slots free of clogging by fibers and dirt particles while in operation.

The screen according to the invention is characterized by the screen structure being designed with profiling, at least on the side facing the fibre suspension and the side facing the reject outlet so that turbulence can be generated in the suspension flowing against the screen structure.

The screen according to the invention in the above or one of the other embodiments described below has the following advantages:
No additional energy requirement except the pumping energy for the feed flow; instead the invention uses the energy flow potential of the feed flow.
No pressure pulsations are generated in the suspension flow during operation.
Virtually any size of screen surface can be built.
There is no air entrapment, which is particularly important for applications as screen in the approach system of a paper machine.
The investment costs are low compared with known screens.
Expenditure for monitoring equipment and instrumentation is low.
The screen according to the invention requires only a small installation area and volume, even at high throughputs.
Screening surfaces can be changed easily.
The screening surface does not suffer wear due to contact with rotating parts.
In “headbox screening” there is no spinning on the screening surface because the flow conditions can be easily adapted on the one hand and on the other, the inner surfaces can be polished at low cost.
If the production plant is extended, the screening area can be enlarged easily and at low cost.
The suspension can be fed through a closed loop so that there is no unpleasant smell emitted and no pollutants escape from the suspension.

In an embodiment of the invention the screen has a structure with a level or curved surface that guarantees rapid and easy exchangeability. For example, the screen structure can also be designed as a screen basket that is installed inside a pipe. Here the suspension flows against the profiled side of the screen structure at high speed so that considerable turbulence is generated in the pulp suspension as it disperses and this prevents the screen structure from becoming clogged. The screen structure or the screen surface of this structure can be installed in a casing with any appropriate orientation, i.e. ascending, descending, in flow direction, or in any combination across the main flow direction, horizontally or vertically.

The screen according to the invention will keep the screen perfectly clear if the screen structure has step-like profiling, where the step height should preferably be between 0.1 and 3 mm, or even better between 0.3 and 1.5 mm.

The screen is easy to manufacture if the screen structure is made up of a large number of bars arranged with narrow spacing. This kind of bar-type screening surface also provides high separating accuracy in fractionation.

In another embodiment of the screen according to the invention, the screen structure comprises a slotted or perforated plate with corrugations, steps or ribs as profiling. The correct profiling shape is selected according to the type of suspension, i.e. depending on the fibre length, fibre stiffness, viscosity, turbulence susceptibility, etc.

Investigations have shown that the best results in terms of throughput and clear screen for applications in the pulp and paper industry are obtained when the slot width or the bar spacing is less than 3 mm and preferably between 50 microns and 1 mm.

It has also proved an advantage to feed the suspension to the screen structure at an angle of 70 to 110°. This configuration leads to high suspension throughput, while keeping the screen structure free of clogging at the same time. In order to optimize flow onto the screen during operation, the suspension feed can be adjustable in such way that the angle at which the suspension flows onto the screen structure can be varied.

In a preferred embodiment of the invention the housing of the separation chamber is of air-tight design, making it possible to operate the screen without any unpleasant odors escaping.

In order to adapt the screen according to the invention to meet varying requirements in terms of pressure needs in the headbox of a paper machine, a pulp suspension pump can be included upstream of the separation chamber.

In order to remove dirt particles from the screen easily via the reject flow, the accept chamber is mounted above the reject outlet in an embodiment of the invention, or the accept outlet points upwards.

The screen structure of the screen according to the invention is made preferably of metal, particularly of stainless steel, or from ceramic or synthetic material. In order to increase the wear resistance of the screen structure, it can be surface-coated, for example by chromizing or nitriding. In order to reduce the susceptibility to spinning, inner surfaces (housing and screen structure surfaces) coming into contact with the pulp can be brushed and/or electrolytically polished.

In order to increase the turbulence, spoiler bars and/or spoiler grooves can be shaped into the screen structure, running in a spiral-shape or in straight lines, for example, and/or having a rectangular, trapezoidal or semi-circular cross-section, or a mixture thereof.

In the screening process, targeted setting of the overflow quantities, i.e. the proportion of reject in the entire pulp suspension fed to the screen, is particularly important. In order to facilitate setting of the overflow quantities, the pulp suspension feed and/or the reject outlet can be fitted with flow controlling elements, such as valves, locks, or shut-off elements. As a result, different pressure chambers can also be formed in a multi-stage screen, where generally the pressure level drops from one screening stage to the next, i.e. the first screening stage has the highest pressure. In certain applications, booster pumps can be included between the screening stages in order to set the pressure level. The flow control elements can be of manually adjustable design. The preferred design, however, is an automatic control system for the flow control elements, where pressure, pressure differential, solid content in the suspension, pulp cleanness or fractionating effect are preferably used as control characteristics.

In a further embodiment of the screen according to the invention, a means of cleaning the screen structure is provided in which the screen is designed so that the accept liquid can be flushed back through the screen structure by the pressure build-up in the accept chamber. The pressure builds up on the accept side by input of compressed air.

When the screen is used as a washer, efficient fractionation of the suspension feed to the screen into organic and inorganic suspension components can be achieved by selecting the correct impact angle, profiling, shape of bars (for bar-type screens), and curve of the screen surface. If sufficient wash water is added to the reject flows, which contain a higher proportion of fibers, the screen can be used as a single-stage or multi-stage washer.

Should it be necessary to clean the screen structure because of suspensions with a particularly tendency to clog (e.g. high proportion of refined long fibers), the screen can be fitted with movable doctors at the screen structure.

As an alternative or in addition to the doctors, pulsators can be provided on the impact side of the screen structure, however an embodiment of this type should not be used in a primary stage ahead of the headbox of a paper machine because of the pressure impulses generated in the suspension and which are transmitted further downstream. In other low-consistency applications, e.g. stock preparation of a secondary stage, this type of embodiment certainly can be used.

The screen according to the invention is excellently suited for use in a multi-stage screening unit, where the individual screens can be arranged in cascade and/or in parallel. The parallel arrangement is used to multiply the screening throughput of an individual screen. The cascading arrangement of the screens, which is also known as “in-line” arrangement, allows different operating parameters to be set in the individual screening stages. Here the arrangement is such that the accept outlet of the first screen—seen in flow direction of the suspension—is the outlet for the screened accept, the reject outlet of each screen is connected to the pulp feed of the following screen, where the reject outlet of the final screen is the outlet for the reject material, and as from the second screen, the accept outlet of each screen is connected to the pulp feed for the preceding screen. Thus, the individual screening, thickening or combined dewatering stages of an entire screening unit can be realized and combined. The operating behavior of the individual stages of the screening unit can be pre-set by a suitable choice of screen structure, particularly its perforation, slot or pore widths. Pumps and/or flow control elements can also be included in connecting pipes between screens in order to influence the operating behavior of the screening unit.

### BRIEF DESCRIPTION OF THE DRAWINGS

The present invention may be better understood and its numerous objects and advantages will become apparent to those skilled in the art by reference to the accompanying drawings in which:

FIG. 1 is a block diagram of a screening unit in accordance with the invention having three screens mounted in series; and

FIG. 2 is a side view of a screen according to the invention.

### DETAILED DESCRIPTION OF THE PREFERRED EMBODIMENT

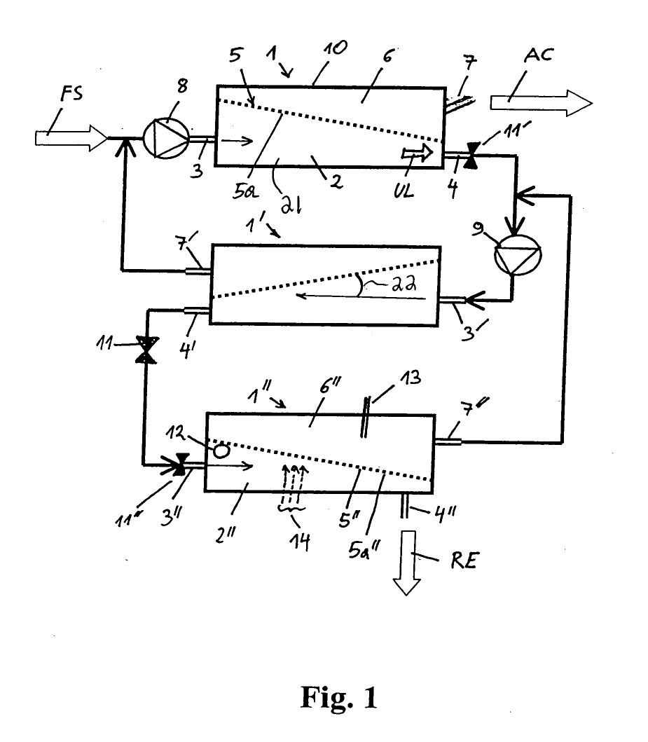

FIG. 1 shows a 3-stage screening unit for cleaning a pulp suspension with the screens 1, 1′, 1″ according to the invention, mounted in series. The three screens are of similar design, which will be described in more detail on the basis of screen 1. The screen 1 for cleaning a pulp suspension FS has a separation chamber 2, defined by a housing 10, with a pulp suspension feed 3 and a reject outlet 4. A pulp suspension FS is conveyed by a pump 8 through the pulp suspension feed 3 into the separation chamber 2. In the separation chamber 2, an accept chamber 6 with an accept outlet 7 pointing upwards is separated from the pulp suspension feed 3 and the reject outlet 4 by a dividing wall 5 with a screen structure 5a. The dividing wall 5 divides the separation chamber 2 asymmetrically into an accept chamber 6 and a suspension chamber 21. The pulp suspension flows onto the screen structure 5a at high speed, where part of the suspension is pressed through the screen structure 5a and is fractionated during this process so that the pulp forming the accept AC collects in the accept chamber 6 and can be removed through the accept outlet 7. According to the invention, the screen structure 5a of the dividing wall 5 has profiling on the side facing the suspension feed 3 and the reject outlet 4, so that turbulence is generated in the pulp suspension FS flowing onto the screen structure 5a. This turbulence pulls any fibers adhering to the slots or perforations in the screen structure 5a and any other solids which could clog it away from the screen structure 5a so that these substances can be removed with the overflow UL of the pulp suspension from the reject outlet 4. The overflow UL is equivalent to the reject in a single-stage screen, which is that part of the pulp suspension that contains fibers of unsuitable length and dirt particles, and is either removed or recycled for further screening. The overflow UL can be controlled by a flow control element 11′ at the reject outlet 4. The dividing wall 5 with its screen structure 5a is shown as a level surface in this embodiment, however curved surfaces etc. can also be used here. Furthermore, the dividing wall descends at an angle (in relation to the flow direction of the pulp suspension). The accept chamber 6 and the accept outlet 7 are located above the reject outlet 4, so that any dirt particles present can easily be discharged downwards with the overflow.

Based on the design of the screen according to the invention with the profiled screen structure, which causes the turbulence mentioned at high inflow speed, the screen structure can be kept free of clogging—particularly at low solids concentration in the suspension—without any need for rotating doctors, pulsators, etc. The self-cleaning screen structure means that this type of screen or a multi-stage screening unit of this type can be used in the approach system of paper or board machines. Excellent self-cleaning effects are achieved, for example at inflow speeds of 0.4 to 6 m/s. The consistency of the pulp suspension should preferably be between 0.02 and 1.5%. The angle of impact is not subject to any particular constraints. It has been shown that particularly good effects are achieved at impact angles 22 between 70 and 110°. The impact angle is calculated within the screen level of the screen structure, starting from the beginning of the bars. An impact angle between 70 and 110 thus means a deviation of ±20° to the vertical on the bars. In order to optimize the impact angle, an adjustable pulp suspension feed or deflection plates, etc., can be provided.

Coming back now to the arrangement of the multi-stage screening unit, the reject outlet 4 of the screen 1 in the first stage is connected via an intermediate pump 9, which is used to set or maintain the pressure in the screen at a constant level, to the pulp suspension feed 3′ of the screen 1′ in the second stage of the screening unit. The accept outlet 7′ of the screen 1′ is connected via a pipe to the inlet of the pump 8 at the first stage so that the accept flow of the suspension withdrawn from the accept outlet 7′ of the screen 1′ can be recycled to the inlet at the first stage. Similarly, the reject outlet 4′ of the second screen 1′ is connected to the pulp suspension feed 3″ of the third screen 1″. The pulp suspension feed 3″ is fitted with an adjustable flow control element 11″. The accept outlet 7″ of the third screen 1″ again leads back through pipes to the pump 9 inlet, i.e. to the second stage. The reject RE remaining after the pulp suspension has passed through the three screening stages is removed from the reject outlet 4″ of the third screen 1″.

Suitable overflow amounts between the individual stages of the pulp suspension to be screened, i.e. the reject portion in each case, lie between 2 and 35%.

If used at a paper machine, the first screen 1 (“primary screen”) can be sized for the pressure requirements in the paper machine headbox by setting the flow rate of the pump 8, thus making this dependent on the production speed. For example, the headbox inlet pressure in this case can be up to 15 bar. The pressures in the second and third screens lie between 0.5 and 5 bar. The pressure difference between the pulp suspension feed and the accept outlet of each screen is preferably between 0.01 and 0.5 bar. On the one hand, the pressures or differential pressures can be set and controlled using the intermediate pump 9 mentioned, but also by means of flow control elements, such as the valve 11. Appropriate screen passage speeds lie between 0.2 and 4 m/s.

If suspensions with a particular tendency to clogging, e.g. pulps with a high proportion of long fibers, are to be screened, the self-cleaning mechanism for the screen structure, achieved by turbulence in the pulp suspension fed in, may not be sufficient and a doctor 12 that moves slowly over the surface of the screen structure may be required in addition to keep the screen structure clear. A further measure to keep the screen structure free of clogging is to provide pulsators 14 on the impact side of the screen structure 5a″, which help to keep the screen structure free of fibers.

Finally, backflow of accept liquid from the accept chamber 6″ of the screen 1″ through the screen structure 5a″ into the separation chamber 2″ can also be used to clean the screen structure. The required pressure build-up in the accept chamber 6″ is achieved by means of compressed air, which is applied through a compressed air inlet 13.

Furthermore, in a multi-stage screening unit the surface speed at the screen structure can be set to different levels in the individual stages, taking account of the specific requirements (concentrations, rheological properties, etc.).

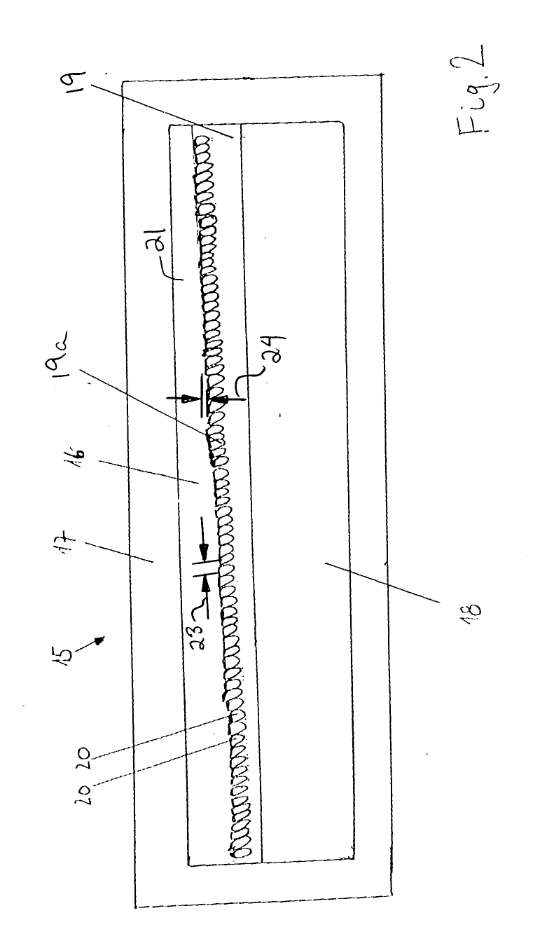

FIG. 2 shows a detailed illustration of a flat bed screen 15 according to the invention. The flat bed screen 15 comprises a housing 17, which can be of air-tight design, and which defines a separation chamber 16 consisting of a pulp suspension feed and a reject outlet, both of which are not shown here, as described above based on FIG. 1. In the separation chamber 16 there is a dividing wall 19 with a screen structure 19a, where the dividing wall 19 partitions the separation chamber into an accept chamber 18 and a suspension chamber 21. The screen structure 19a is formed by a large number of bars 20 positioned one beside the other, with spacing 23 of 80 microns to 0.5 mm, for example, between the bars. The cross-section and orientation of the bars 20 are such that the screen structure has profiling formed by steps between the individual bars, where an appropriate step height 24 is between 0.3 and 1.5 mm. The steps between the bars are formed by the bars lying on a slant. As an alternative to a screen structure made up of individual bars, the screen structure can be made of slotted or perforated plates, where, for example, step-type profiling can be obtained by milling out of a solid sheet metal plate. In addition to the step-like structure, corrugations or ribs can also be shaped into the metal plate in order to generate the turbulence required to keep the screen structure clear. For slotted plates, an appropriate slot width is somewhere below 3 mm. The bars 20 in the screen structure 19a are made of metal, particularly of stainless steel. It would also be possible, however, to use screen structures made of ceramic or synthetic material. The bars can be surface-coated in order to provide greater wear-resistance.

In order to generate greater and stronger turbulence, the screen structure can also be fitted with spoiler strips and/or spoiler grooves, running in a spiral shape or in a straight line, for example, and/or having a rectangular, trapezoidal or semi-circular cross-section, or a mixture thereof.

While preferred embodiments have been shown and described, various modifications and substitutions may be made thereto without departing from the spirit and scope of the invention. Accordingly, it is to be understood that the present invention has been described by way of illustration and not limitation.

1. A screen for cleaning a pulp suspension comprising:
a housing defining a separation chamber and including
a pulp suspension feed for receiving a flow of the pulp suspension,
a reject outlet and
an accept outlet; and
a dividing wall disposed within the housing and dividing the separation chamber into a suspension chamber and an accept chamber, the pulp suspension feed and the reject outlet being in fluid communication with the suspension chamber and the accept outlet being in fluid communication with the accept chamber, the dividing wall having a screen structure having a suspension side adjacent the suspension chamber and an oppositely disposed accept side adjacent the accept chamber, at least the suspension side of the screen structure having profiling for generating turbulence in the pulp suspension flowing against the screen structure.

2. The screen of claim 1 wherein the screen structure has a level or curved surface.

3. The screen of claim 1 wherein the screen structure has step-like profiling having a step height of between 0.1 and 3 mm.

4. The screen of claim 1 wherein the screen structure includes a plurality of bars arranged with narrow bar spacing.

5. The screen of claim 1 wherein the screen structure comprises a slotted or perforated plate with corrugations, steps or ribs.

6. The screen of claim 4 wherein the bars define a bar spacing of less than 3 mm.

7. The screen of claim 1 wherein the pulp suspension feed directs the flow of pulp suspension onto the screen structure at a flow angle of 70 to 110°.

8. The screen of claim 1 wherein the pulp suspension feed directs the flow of pulp suspension onto the screen structure at a variable flow angle.

9. The screen of claim 1 wherein the housing is air-tight.

10. The screen of claim 1 further comprising a pulp suspension pump disposed upstream of the pulp suspension feed.

11. The screen of claim 1 wherein the accept chamber is disposed above the reject outlet.

12. The screen of claim 1 wherein the screen structure is composed of a material comprising metal, ceramic or synthetic material.

13. The screen of claim 1 wherein the screen structure has a surface coating for increasing wear resistance.

14. The screen of claim 1 wherein the screen structure has spoiler bars and spoiler grooves, extending in a spiral-shape or in straight lines.

15. The screen of claim 1 wherein at least one of the pulp suspension feed or the reject outlet includes a flow control element.

16. The screen of claim 15 wherein the flow control element adjusts the flow on the basis of a parameter comprising pressure, pressure differential, solid content in the suspension, pulp cleanness or fractionating effect.

17. The screen of claim 1 further comprising an accept chamber pressurizing device for flushing accept liquid back through the screen structure.

18. The screen of claim 1 further comprising at least one pulsator disposed on the suspension side of the screen structure.

19. The screen of claim 1 further comprising at least one movable doctor disposed adjacent the screen structure.

20. The screen of claim 3 wherein the step height is between 0.3 and 1.5 mm.

21. The screen of claim 6 wherein the slot width or the bar spacing is between 50 microns and 1 mm.

22. The screen of claim 1 wherein the accept outlet extends upwardly from the housing.

23. The screen of claim 12 wherein the screen structure is composed stainless steel.

24. The screen of claim 14 wherein the spoiler bars and spoiler grooves have a rectangular, trapezoidal or semi-circular cross-section, or a mixture thereof.

25. The screen of claim 15 wherein the flow control element comprises a valve, lock, or shut-off element.

26. The screen of claim 5 wherein the slotted plate defines a slot width of less than 3 mm.

27. A multi-stage screening unit comprising a plurality of screens arranged in a series flow path, whereby the screens define prior and subsequent screens, each of the screens comprising:
a housing defining a separation chamber and including
a pulp suspension feed for receiving a flow of the pulp suspension,
a reject outlet and
an accept outlet; and
a dividing wall disposed within the housing and dividing the separation chamber into a suspension chamber and an accept chamber, the pulp suspension feed and the reject outlet being in fluid communication with the suspension chamber and the accept outlet being in fluid communication with the accept chamber, the dividing wall having a screen structure having a suspension side adjacent the suspension chamber and an oppositely disposed accept side adjacent the accept chamber, at least the suspension side of the screen structure having profiling for generating turbulence in the pulp suspension flowing against the screen structure;
wherein the accept outlet of a first prior screen is an accept outlet of the screening unit, the reject outlet of a final subsequent screen is a reject outlet of the screening unit, the accept outlet of each subsequent screen is in fluid communication with the pulp suspension feed of the prior unit, and the reject outlet of each prior screen is in fluid communication with the pulp suspension feed of the subsequent screen.

28. The multi-stage screening unit of claim 27 further comprising a pump disposed between each prior and subsequent screen.

29. The multi-stage screening unit of claim 28 further comprising a flow control element disposed between each prior and subsequent screen.

30. The multi-stage screening unit of claim 27 further comprising a flow control element disposed between each prior and subsequent screen.
